(19) United States
(12) Patent Application Publication
(10) Pub. No.: US 2003/0017313 A1
(43) Pub. Date: Jan. 23, 2003

(54) Roofing membrane with vapour pressure control

(75) Inventor: Richard Pelander, Helsinki (FI)

Correspondence Address: OLIFF & BERRIDGE, PLC, P.O. BOX 19928, ALEXANDRIA, VA, 22320, US

(73) Assignee: ICOPAL OY, Espoo (FI)

(21) Appl. No.: 10/215,027

(22) Filed: Aug. 9, 2002

Related U.S. Application Data
(63) Continuation of application No. PCT/FI01/00154, filed on Feb. 16, 2001.

(30) Foreign Application Priority Data
Feb. 18, 2000 (FI) 20000381

(51) Int. Cl. B32B 3/00

(52) U.S. Cl. 428/195

(57) ABSTRACT

The invention relates to a roofing membrane to be used as a primer and/or topping sheet, the lower surface of which membrane is covered throughout with a continuous welding bitumen layer, the surface of which has a protective layer comprising alternating stripes (A) and (B), a first stripe (A) being of welding plastic or the like, which melts as heated, whereby the welding bitumen beneath the stripe also melts, a second stripe (B) being of non-melting material or material that otherwise prevents the welding bitumen beneath from melting.

The invention relates to a roofing membrane with vapour pressure control, a lower surface of which membrane is covered throughout with a continuous, welding bitumen layer, the surface of which has a protective layer comprising alternating stripes (A) and (B), one stripe (A) being of welding plastic or the like, which melts as heated, whereby the welding bitumen beneath the stripe also melts, the other stripe (B) being of non-melting material or material that otherwise prevents the welding bitumen beneath from melting.

The roofing membrane of the invention can be used as a primer and/or a topping sheet.

The roofing membrane of the invention can be manufactured from blown bitumen, bitumen modified with rubber or plastic, or from suitable plastic material. The reinforcement layer of the roofing membrane can be of polyester (basis weight being e.g. 80 to 350 g/m²) or glass fibre (basis weight being e.g. 40 to 200 g/m²) or wood fibre or textile felt (basis weight being e.g. 100 to 600 g/m²) or combinations thereof.

The stripes of the protective layer can be of plastic or metal, or of fluid, e.g. sprayable, substance or combinations thereof.

The structure of the roofing membrane of the invention is known per se, but the lower surface of the roofing membrane is covered throughout with a continuous welding bitumen layer the surface of which has a protective layer comprising stripes. A first stripe (A) is of welding plastic or the like, which melts as heated with a torch or a hot-air blower, whereby the welding bitumen beneath the stripe simultaneously melts and the roofing membrane adheres to its base. A second stripe (B) is of material that does not melt but acts as a permanent protective layer, so the welding bitumen beneath said material does not melt nor adhere to the base in these areas. The material of the stripe (B) can also otherwise prevent the welding bitumen from melting.

The roofing membrane of the invention is manufactured by providing the lower surface of the roofing membrane known per se with a continuous welding bitumen layer that is protected with said protective layer.

The advantages of the roofing membrane of the invention:

there is no need to provide the lower surface of the roofing membrane with separate welding bitumen stripes or welding bitumen patterns (e.g. diamond patterns, circles or squares) or the like, which add to the thickness of the roofing membrane and increase the manufacturing costs;

the seams of the roofing membrane can be joined by removing from the end area of the roofing membrane the plastic with a higher melting point and by heating the welding bitumen;

the roofing membrane manufactured by means of a novel membrane has an even surface;

thanks to the novel method, a thinner reinforcement layer can be used in the roofing membrane without the surface being uneven.

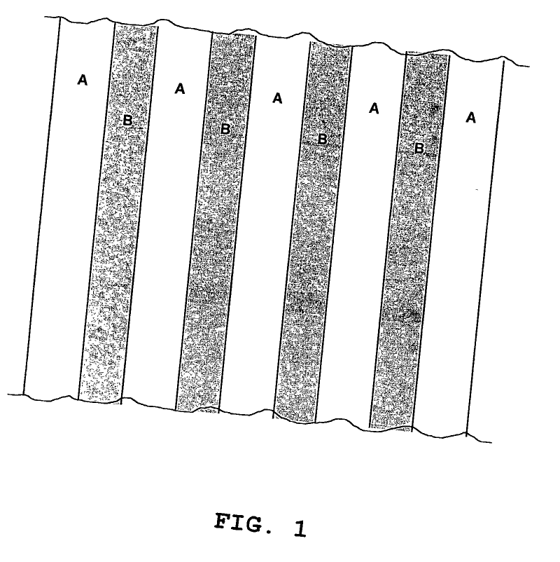

FIG. 1 shows a protective layer which consists of alternating stripes (A) and (B).

1. A roofing membrane with vapour pressure control, a lower surface of which membrane is covered throughout with a continuous, welding bitumen layer, the surface of which has a protective layer comprising alternating stripes (A) and (B), wherein a first stripe (A) is of material that melts as heated, or that otherwise allows the welding bitumen to melt and adhere to a base, and a second stripe (B) is of material that does not melt or that otherwise prevents the welding bitumen beneath from melting and adhering to the base.
